(19) United States
(12) Patent Application Publication
(10) Pub. No.: US 2004/0080621 A1
(43) Pub. Date: Apr. 29, 2004

(54) Electronic camera with onboard image manipulator

(76) Inventors: Ken Scott Fisher, Los Angeles, CA (US); Kevin Cotton Baxter, Santa Clarita, CA (US)

Correspondence Address: KEN FISHER, 5521 CLEON AVE., NORTH HOLLYWOOD, CA, 91601, US

(21) Appl. No.: 10/227,972

(22) Filed: Aug. 26, 2002

(51) Int. Cl. H04N 5/225

(52) U.S. Cl. 348/207.99

(57) ABSTRACT

An integrated electronic camera and software package that can change the characteristics of captured images (such as color, brightness, and contrast). By the operation, the camera device includes onboard image manipulation software and utilizes the existing camera monitor, and thereby allows the user to directly alter captured images to suit their personal preferences.

### BACKGROUND

1) Technical Field of the Invention

The present invention pertains generally to digital cameras, and more particularly, for example, to a method and apparatus for improving captured digital images.

2) Background of Invention

To fully appreciate the present invention as it relates to the background, a cursory understanding of digital camera systems and image manipulation techniques (along with their limitations) is helpful. Digital camera systems, of course, are well known in the art. While such digital camera systems have delivered low-cost, instant display imagery to the masses, there are still a number of inherent limitations, which lead to a need for additional processing approaches when optimized imagery is required.

Prior art conventional film-based cameras (including models with sophisticated auto-exposure) have almost always included secondary intervention on the captured images, e.g., basic manipulation at a photo lab (e.g., color, brightness, etc.). At such a facility, there are usually high-priced sensors and processing machines, which can automatically detect problems with captured images, and thereby correct such deficiencies prior to the actual printing process. Such systems may also be designed to give the client's prints an overall “warm” more pleasing skin tone (e.g., “healthy”).

From an overview standpoint, the current-day “digital” approach is to also separate the camera system, from the post-capture image optimization process. Even with high-performance professional digital camera systems (e.g., approximately $5,000 per systems, such as the Canon® EOS-1, as sold by Canon USA, www.usa.canon.com), one must still utilize external devices to optimize the captured images. The printing of digital imagery itself has tended to be an “in-house” operation, with the user typically handling all of the required steps. This added level of complexity has not only discouraged image optimization, but has discouraged even the “basic” printing of the digital image themselves (e.g., the “hassle” factor).

The increasing use of digital cameras has revealed various problems with optimizing captured images. For example, a user may take a picture, and the resulting digital image looking too dark (or too light), and/or the contrast may be too high (or low), and/or the color may have shifted to a less than optimal tone. Even if such a system has captured an overall neutral image, it only provides the basic image, without considering the user's visual requirements or preferences. As a result, the image is not optimized for the user's specific needs. Some prior devices have the ability to set a basic white point balance (e.g., lighting conditions such as daylight, or tungsten, or manually) and/or allow the basic cropping of an existing image. There currently exists no means within digital cameras to adjust numerous settings after image capture.

One solution to such problems is to use a computer with image manipulation software. Wherein the digital data file itself is transferred from the camera to a host computer system for manipulation. This of course involves the purchase or access to a full computer system and related image manipulation software. Generally this can be a complex process, and one could also spend a good deal of time just tending to all the software and hardware to connect, sync, adjust and disconnect the devices, in order to achieve satisfactory prints. There also may be compatibility issues, such missing drivers. In addition, there are size and weight issues, wherein a much smaller integrated device would be more advantageous.

Such systems tend to be much bulkier than the present “integrated” invention as will be described herein, and thus lack ease of portability.

Another less common solution is to use a printer with an onboard visual display and image manipulation software. This has created a problem wherein a user would be required to purchase a much more costly printer, than would be otherwise be necessary. In addition, there may be file incompatibility issues, such as the wrong memory cartridge interface on the printer.

One notable feature of some modem digital cameras is their ability to print directly from the camera to the printer. This is usually accomplished via a direct cable means (e.g., USB cable), although alterative systems such as wireless have also been proposed (e.g., Bluetooth, Ultra-Wide Band, infrared, and so on). It should be noted that this direct to printer mode currently lacks the ability to fully optimize the image (e.g., secondary intervention as outlined above).

In many cases, a digital camera has a relatively large liquid crystal display (LCD) on its rear face or the like. This has allowed the previewing of captured images, and thereby giving the user the immediate option of “re-shooting”. Although, it should be noted that there exists times and places where it may impossible to re-stage the captured shot, e.g., a graduation handshake, or a baby's first steps. Some cameras such as the Minolta® DiMAGE S404, as sold by Minolta USA of Ramsey, N.J. USA, www.minoltausa.com, have an effects control system that allows a user to vary some of the image characteristics, via image previewing, on the monitor “prior” to image capture.

The LCD also has the function corresponding to an optical finder in an optical camera. By carrying out the live preview display on the liquid crystal display as well, the user can capture an image while checking an image of the subject to be captured (e.g., cropping). Such a display could also be utilized for other purposes. This may lead a user to attempt to adjust an image prior to capture, and there possibly losing that shot altogether, during such adjustment.

Microprocessors, RAM and flash memory are used in many devices, including video cameras, digital cameras, laptop computers, portable digital assistance devices (e.g., palm pilots), portable video games, and other devices. It should be noted that in general, the cost of such microchips is continuing to drop, and additionally, today's microprocessors are providing faster processing capabilities, even at these lower price points. This trend is expected to continue. This same power/price trend also exists in memory, e.g., flash ram drives at a 1 gigabyte capacity at a greatly reduced price/capacity ratio, this is also true of micro drives (now at 10 gigabyte capacity), and 250 megabyte RAM chip sets at $65/ea., and so on). All of this points to the potential of increased cost-effective processing means contained within a compact digital camera. Battery capacity has also seen great strides in the last few years, with many more improvements on the horizon.

Image manipulation techniques (e.g., improvements in color/hue, brightness, contrast, saturation, and sharpness, to name a few) and the related software are well known in the art, and as such, does not warrant a fully detailed discussion herein. Adobe Photoshop software version 7, as sold by Adobe Systems of San Jose, Calif. USA, along with the accompanying Adobe® Photoshop® 7 User Guide for Windows® and Macintosh® (Adobe, part number 90036869, April 2002) is hereby incorporated herein by reference in its entirety, including pages 256 through 260 on image corrections. Additional books hereby incorporated herein by reference in their entirety, include Photoshop 7 Artistry Mastering the Digital Image Copyright 2002, as sold by New Riders Publishing of Indianapolis, Ind., USA, and Photoshop Down and Dirty Tricks, Author Scot Kelby, Mar. 2002, also sold by New Riders of Indianapolis, Ind., USA (downanddirtytricks.com), and finally Adobe Photoshop 7 Classroom in a Book, copyright 2002, as sold by Adobe Systems of San Jose, Calif. USA. Photoshop is considered by many to be the industry standard image manipulation software program, and enjoys wide success throughout the world. These reference sources describe in detail the vast majority of common image manipulation approaches.

It should also be noted that there is a new emerging class of small low-cost portable printers, e.g., no display or image manipulation software, but having multiple memory card type access (e.g., both Sony® Memory Stick, and Smartdisk® Media). This now allows one to take a portable digital camera and the small portable printer to a family event or party, thereby giving the ability to hand out finished printed digital photographs almost immediately. Again, there is no means provided to fully optimize the printed files within such a setup.

Automatic exposure control is now commonplace for digital cameras. Such cameras have been known that divide a photographic scene into several areas when measuring subject brightness. An exposure value is calculated based on respective brightness values of these areas after weighting each value with an appropriate coefficient. At that moment, it is determined from the divisional brightness values, whether the scene is front-lighted or back-lighted, and the onboard flash unit may also be employed. In such systems, it is never guaranteed to achieve a satisfactory exposure with respect to both main subject and subsidiary subject matter.

All of this points to expensive hardware, lost time and efficiencies, and the real possibility of not having optimized imagery.

Heretofore, a barrier has essentially existed for users who wish to optimize their captured imagery directly from their digital camera system. There would be remarkable advantages in portability, efficiencies and ease of use, if the user-defined or “pre-canned” image manipulations could be implemented directly “in-camera”.

As a result, a need exists in the art for a method and apparatus that provides the digital camera user with an onboard image manipulation means for optimizing captured images printed directly from the camera.

A primary object of the present invention is to provide a new, novel and useful method and apparatus, which is extremely portable and does not require an external computer or an expensive image-manipulation printer.

A further object of the present invention is to provide an improved “integrated” method and device as characterized above which by its nature is more intuitive to use and thereby enhances the user's enjoyment and efficiency.

### SUMMARY OF THE INVENTION

An integrated image capture system: a portable digital image capture device; and image manipulation software. The manipulation software provides a user with the ability to adjust the captured imagery to suit his or her personal preferences, directly from the camera itself.

According to a first aspect of the invention, an electronic camera includes: a display for displaying an image of a subject; and a software corrector for correcting captured images, by changing the actual stored digital file characteristics, e.g., writing over the existing file, or creating a new “altered” image file, in accordance with the user's preferences. Since the digital camera device typically already has a means to display a captured image, the resulting inventive combination provides a more low-cost approach over prior art systems.

According to a second aspect of the invention, an image “filter” or “layer” is added and/or linked to the data file. Such an approach may save on onboard processing requirements. Such a filter approach is notated in the incorporated reference material, and may be attached as a layer filter, so as not to alter the underlying digital file (or to not require the existing file to be re-written). This can be accomplished by one skilled in the art.

The inventive device is integrated with a standard printer (or computer pr storage device), via an industry standard interface (e.g., USB port, Firewire port, and wireless means, such as Bluetooth, or Ultra-Wideband). The integrated system has significant performance enhancements over prior art approaches, and fulfills a long felt need for a simpler, more cost effective integrated camera approach as described herein.

Attention needs to be paid to the real world, wherein ease of use is critical; the inventive system allows a user to simply and easily adjust their captured images, while still using only their integrated camera system, and thereby allowing the ability to go directly to the print stage. Great strides have been made to simplify user interfaces in the last several years, yet many people still struggle with computers. With the inventive system, manipulating an image as stated herein would of course be much more simplified, but even more important, the operating mechanics of the camera/optimization process would be much more transparent to the user, and thereby greatly aid in ease of use. This integrated approach is extremely important, especially as the world moves towards the new wireless frontier (e.g., Bluetooth, Ultra Wide Band) for printing and image archiving.

The invention is distinguished over the known prior art in a multiplicity of ways. For one thing, the invention allows the user the opportunity to initiate correction work immediately after capture. Equally as important, however, is the ability in another embodiment to have an “auto correct” button (e.g., well known in the art—i.e., Photoshop) to provide the user with the ability to automatically correct and adjust their imagery.

In yet another embodiment, the integrated solution may also include a “pre-canned” effects buttons (e.g., warm sunset look, suntan look, red-eye reduction, cross-processed effect, etc.) Such pre-canned effects can be accomplished by one skilled in the art.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The present invention is illustrated by way of example and not by way of limitation in the figures of the accompanying drawings in which references indicate similar elements and in which:

FIG. 1 is a block diagram of the instrumentality and data flow according to the present invention.

### DETAILED DESCRIPTION OF THE INVENTION

Before describing in detail the portable memory system in accordance with the present invention, it should be observed that the present invention resides primarily in what is effectively a novel combination of software and emerging digital capture devices, and not in the particular detailed configurations thereof. Accordingly, the structure, control and arrangement of the software, circuits and components have been illustrated in the drawings by readily understandable block diagrams which show only those specific details that are pertinent to the present invention, so as not to obscure the disclosure with structural details which will be readily apparent to those skilled in the art having the benefit of the description herein. Thus, the block diagram illustrations of the Figures do not necessarily represent the mechanical structural arrangement of the exemplary system, but are primarily intended to illustrate the major structural components of the system in a convenient functional grouping, whereby the present invention may be more readily understood.

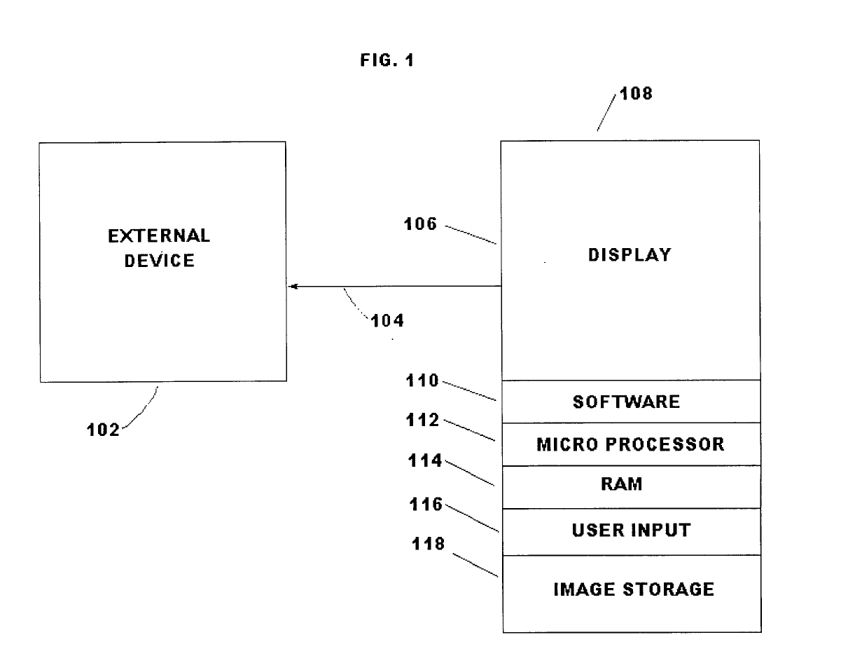

Referring to FIG. 1 there is illustrated the system overview in accordance with the present invention. Camera 108 (only one exemplary camera is shown) which may include a connector port (not shown) such as USB or Firewire (or via other communications as stated herein) for communications with external device 102. In more detail, external device 102 may be a printer, computer, or external storage device. FIG. 1 also shows the data flow from the camera 108 to external device 102, via communications 104. Besides USB or Firewire, such communications 104 may also consist of any industry standard communications means (e.g., direct physical connection, PCMIA, Local Area Network (LAN), a Wide Area Network (WAN), the Internet, a telecommunication network and wireless options such as cellular communication, infrared, Laser, radio frequency means (RF), Bluetooth, DSSS, Ultra Wideband, wireless LAN or WAN) or other connection means. Communications 104, may include an antenna for the wireless embodiment, as is well known in the art.

In one embodiment, the inventive device 108 further comprises a mechanism, such as a micro-switch 116 that allows a user to initiate a wireless data transmission to external device 102. Additionally, a visual display mechanism can be provided on the memory device to show the current state of connection and data transmission 104.

As shown in the drawings, the digital camera 108 has onboard image manipulation software 110 for adjusting captured images, by way of a non-limiting example, this may include improvements in color balance (e.g., more warm or cool in tone, mimicking a 81D camera filter, or 80A camera filter, moving closer to 5500 degrees Kelvin temperature, moving closer to 3200 Kelvin temperature), contrast (e.g., adding or reducing), saturation (e.g., adding or reducing), selective cloning (e.g., copying an adjacent image area for acne removal), burning and/or dodging (selectively lighting or darkening specific areas of a captured image), and, gamma (e.g., adding or reducing brightness), to name a few, via user input 116 and previewed on display 106. Such image manipulation techniques are well known in the art, and the integration into camera systems can be accomplished by one skilled in the art. Display 106 may be a monitor (e.g. LCD, conventional), and may be directly attached, or be a remote plug in monitor (e.g., improved color rendition). User input 116 may consist of any common input device such as a scroll wheel, multi-way rocker switch, and so on. Image manipulation software 110 may utilize the systems microprocessor 112 and RAM 114. A variable adjustment wheel 116 or other means may be included to “dial-in” the desired adjustments. In addition, a print size selection means may also be included.

Software 110 may also employ any of image manipulation approaches described herein as a “pre-capture” adjustment tool. Any effect could be previewed on display 106 prior to the actual image capture. Such an approach would be an extremely valuable addition to the art.

Captured images may be stored in image storage 118. Regarding the storage device 118 itself, it may be a memory card, a memory cartridge, a floppy disk, a removable hard disk, a flash memory drive, flash drive card, PCMIA memory card, embedded memory, a micro-drive, or the like. If image storage 118 is removable, it may also interface directly with external device 102.

As envisioned herein, the term “image manipulation” may include any adjustments described herein and/or described in the incorporated reference sources. By way of example, and not limitation, this may included pixel interpolation (e.g., upping the resolution for larger prints, image sharpening, defocus or soft focus effects, alpha channels, brushes (e.g., selection, adjustment), color management (e.g., camera to printer calibration), conversions (e.g., file formats), erasing, duplicating, eyedropper (e.g., set black point and/or white point and/or gray point for optimizing files), image adjustment previews, disproportionate aspect ratio changes (e,g., stretch—weight loss effect, overdone for a humor effect), lighting effects, magic wand tool, masking options, perspective manipulation, pre-set filter packs, scaling, texture options, undo, and so on. All such techniques are extremely common in the image editing world, and can be incorporated into the inventive device 108 by one skilled in the art, with the benefit of the disclosure described herein. Such adjustments may be used on a localized portion of an image (e.g., selected area), or may be used globally to include the entire image. Software 110, may keep a history list, thereby allowing a selective undo of any of the previously applied adjustments.

The image capture device 108 may be a video cameras, still digital cameras, or integrated devices including image capture devices such as laptop computers, portable digital assistance devices (e.g., palm pilots), portable video games, mobile phones and other similar devices

While the present invention has been described with reference to specific exemplary embodiments, it will be apparent to those skilled in the art that various modifications and changes may be made to these embodiments without departing from the broader spirit and scope of the invention as set forth in the claims. Since modifications of the disclosed embodiments incorporating the spirit and substance of the invention may occur to persons skilled in the art, the invention should be construed to include everything within the scope of the appended claims and equivalents thereof. Accordingly, the specification and drawings are to be regarded in an illustrative rather than restrictive sense.

What is claimed is:

1) An integrated camera system comprising:
a digital image capture device;
a memory device housed within said digital image capture device;
a display for displaying a captured image of a subject stored on said memory device; and
image manipulation software housed within said digital image capture device,
wherein said image manipulation software provides a corrector adjust for correcting said captured image.

2) The integrated camera according to claim 1, wherein said corrector adjust is a change in image color balance.

3) The integrated camera according to claim 1, wherein said corrector adjust is a change in image contrast.

4) The integrated camera according to claim 1, wherein said corrector adjust is a change in image gamma.

5) The integrated camera according to claim 1, wherein said corrector adjust is a cloning action.

6) The integrated camera according to claim 1, wherein said corrector adjust is a change in image saturation.

7) The integrated camera according to claim 1, wherein said corrector adjust is a pixel interpolation action that increases the file for improved printing.
